(19) United States
(12) Patent Application Publication
(10) Pub. No.: US 2007/0230175 A1
(43) Pub. Date: Oct. 4, 2007

(54) Nightlight with enhanced edge illumination and increased durability

(76) Inventor: Max Edward Montgomery, Santa Cruz, CA (US)

Correspondence Address: MAX E. MONTGOMERY, 322 ALTA AVE., SANTA CRUZ, CA, 95060, US

(21) Appl. No.: 11/732,572

(22) Filed: Apr. 4, 2007

Related U.S. Application Data
(60) Provisional application No. 60/788,960, filed on Apr. 4, 2006.

(51) Int. Cl. F21S 13/14

(52) U.S. Cl. 362/252

(57) ABSTRACT

Enclosed herein is a design and method for creating a decorative extruded translucent or transparent nightlight shape where the outer edge illumination of said extruded core shape is enhanced when said core shape is illuminated by an internal light source and also when illuminated by ambient light. This is accomplished by adding a rough bevel to the edge of the decorative extruded core shape to refract light back to the face near the shape's edge. The edge of said core shape appears brighter than that of the center of said core shape or that of the light source and is also visible from angles perpendicular or close to perpendicular to the facing edge of said shape, not just the side angle viewing delivered by a square edge. The outer edge illumination is further intensified by creating the translucent or transparent core shape element out of a hard or flexible material with edge glow doping. The outer edge illumination is further increased by using a cover diffusing element which obscures at least one portion of the core shape on the opposite side from the light emitting element and redirects light back into the core shape. In addition, new translucent or transparent core shape materials are introduced that increase the durability of extruded nightlight shapes, particularly those with intricate designs.

### CROSS REFERENCE TO RELATED APPLICATIONS

This application claims the benefit of provisional patent application Ser. No. 60/788,960 filed on Apr. 4, 2006.

### BACKGROUND

1. Field of Invention

This invention relates to nightlights, specifically to improved methods and materials for creating translucent or transparent nightlights with an enhanced edge illumination and increased durability.

2. Description of Prior Art

The key utility value of a nightlight is in softly illuminating a dark room or hallway, however, the decorative aspects of a nightlight may be of greater value to the purchaser and user. As outlined by Rochford and Rochford's Decorative Guide Light patent (U.S. Pat. No. 3,818,212) nightlights traditionally spread light evenly throughout a decorative shape via a diffuser in front of the light source. This can also be accomplished by using a diffuser in conjunction with a shape composed of multiple layers of materials of different colors, depths, or translucency properties as outlined in Rochford and Rochford's Cast Resin Glow Lamp Product patent (U.S. Pat. No. 3,818,213). Those methods and those outlined in Piepgras, et al's Light Emitting Diode Based Products Patent (U.S. Pat. No. 6,965,205) may also be used to accent certain inner aspects of a shape when illuminated. Traditional cavity nightlights, of which there are many similar to Yuen's Flower Shape Night Light Design Patent (U.S. Pat. No. D482,466) are hollow shapes surrounding a light source. There are also a number of face plate nightlights, where a design shape is placed on the nightlight in front of the light source, such as Hollinger's Acrylic Night Light Cover Design Patent (U.S. Pat. No. D426,910). Either of these design types may utilize different colored plastics or paints to enhance portions of a shape.

Burdick's Led Night-Light Patent Application (App. 20040246704) focuses on highlighting physical objects embedded inside of a translucent shape. Products such as the LOMAK 310603 Neon Guide Light use a scribed line on the edge to refract light and enhance edge glow on a night light shape when illuminated. The scribed line, however, adds no visible effect to the shape when not lit. There are a number of nightlights designs using a smooth truncated double-bevel edge to enhance edge illumination of a translucent extruded shape as shown in Gee's LED Night Light Design Patent (U.S. Pat. No. D460,573). The edge somewhat illuminates when plugged into a power source, but no such effect is visible with ambient light alone, and the focus of such designs is to accent the etched and painted design in the interior of the shape not the outline of the shape itself. In addition Gee's LED Night Light Design Patent (U.S. Pat. No. D460,573) shows an etched and painted design inside the translucent shape, which could be applied to the outer edge. Some use the end of fiber optic materials to create an illuminated edge, as Salamander Graphix does with Part # 11373—Fiber Optic Butterfly Nightlight. While producing an effective edge glow when illuminated by a light source, nightlights made in this manner are fragile, limited in form, expensive to manufacture and don't display any enhanced edge glow when not illuminated.

Nightlights are traditionally made of rigid translucent or transparent materials such as plastic, acrylic, or glass that can easily break. Those with intricate designs are particularly fragile. The invention also addresses this limitation.

The prior art listed reflects the state of the art of which the applicant is aware. None of these references teach singly nor render obvious when considered in any combination the invention as disclosed in greater detail and as later claimed.

The problems with the prior art is that it:
Doesn't adequately provide light to the outer edge of the core nightlight shape while illuminated.
Doesn't adequately provide light to the outer edge of the core nightlight shape while not illuminated. This is one of the key challenges to nightlight manufacturers as the packaging does not adequately present the nightlight's design features while in the package.
Doesn't provide a good outline view of the edge when looking perpendicular to the face of the core nightlight shape when illuminated.
Doesn't provide a good outline view of the edge when looking perpendicular to the face of the core nightlight shape when not illuminated.
Can be costly and time consuming to manufacture nightlights using multiple layers of material.
Is prone to breakage with accidental physical contact or that by foreign objects such as furniture.

### OBJECTS AND ADVANTAGES

Accordingly, these problems are overcome with the present invention. Enhanced edge illumination can be produced and amplified by utilizing plastic doping type materials. There are new heat and light stable edge glow compounds utilizing dyes that absorb UV light and re-admit that energy in longer wavelengths. Effectively this changes non-visible light to a visible wavelength and refocuses internal light reflection within the compound, emitting it more intensely along edges, thereby creating a glowing effect. The applicant is unaware of any nightlights being made with such material and will make claim to such material use. However, even with such material, the edge glow effect is best viewed from the side, not perpendicular from the face of the edge shape. Edge illumination from all angles, particularly that perpendicular to the face of the edge shape, can be greatly enhanced by designing the core light shape with rough beveled edges as is further detailed in this application. The applicant is also unaware of any nightlights being made with flexible, translucent or transparent, heat-resistant materials such as silicon and will make claim to such material use with and without edge glow compounds. Such material allows any core shape, especially those that with an intricate configuration, to be flexible and more durable than their traditional, rigid material counterparts. They can also touch or encase the light source and transmit more light to all parts of the translucent or transparent core shape, further enhancing edge illumination.

My method of enhancing nightlight edge illumination and increasing durability is preferable over previous methods because it:
Makes visible the illuminated edges when the shape is viewed perpendicularly, or face on.
More clearly highlights the edge of the translucent or transparent core shape element while illuminated.
More clearly highlights the edge of the translucent or transparent core shape element while not illuminated.
   This feature is key to manufacturers as nightlights like this appear to glow in the package, even without a power source, providing a more realistic display of the nightlight's design effect, which help the product stand out from others on store shelves, show rooms, tradeshows, and other locations. This feature is also beneficial for consumers as it provides an effect that can be viewed in the daytime by the nightlight owner as well.
Lights the edge without a light source behind it.
More evenly distributes light to the edge of the translucent or transparent core shape element.
Is inexpensive to manufacture nightlights that provide such an effect.
Creates a unique new look for extruded nightlights.
Enhances the decorative aspect of nightlights with such an effect.
Creates a safer more durable nightlight that is more resistant to breakage, particularly those with intricately shaped designs.

### BRIEF DESCRIPTION OF THE DRAWINGS

FIG. 1 is a front perspective view of a one embodiment the present invention;

FIG. 2 is a back perspective view of the nightlight shown in FIG. 1;

FIG. 3 is a front facing view of the nightlight shown in FIG. 1;

FIG. 4 is a back facing view of the nightlight shown in FIG. 1;

FIG. 5 is a top view the nightlight shown in FIG. 1;

FIG. 6 is an exploded cut away top view of the nightlight shown in FIG. 1;

FIG. 7 is a cut away zoomed in view of a translucent or transparent core shaped element with a square edge and a simplified illustration of the way light travels to the edge through said shape;

FIG. 8 is a cut away zoomed in view of a translucent or transparent core shaped element with a rough beveled edge and a simplified illustration of the way light travels to the edge through said shape and back to the face;

FIG. 9 is the facing view of the nightlight with a standard squared edge shown in FIG. 7;

FIG. 10 is the facing view of the nightlight with the rough beveled edge shown in FIG. 8;

FIG. 11 is a front facing view of a nightlight built in the same manner and with the same material as that shown in FIG. 1 but using an alternate translucent or transparent core shape element;

FIG. 12 is the side facing view of the nightlight show in FIG. 11;

FIG. 13 is a front facing view of a nightlight built in the same manner and with the same material as that shown in FIG. 1 but using two translucent or transparent core shape elements layered and turned offset over each other;

FIG. 14 is the side facing view of the nightlight show in FIG. 14;

FIG. 15 is a front facing view of a nightlight built in the same manner and with the same material as that shown in FIG. 1 but using a flexible extension design element to the power source in the base;

FIG. 16 is the side facing view of the nightlight show in FIG. 15;

FIG. 17 is a front facing view of a nightlight built in the same manner and with the same material as that shown in FIG. 15 but using multiple translucent or transparent core shape elements and multiple flexible extension design elements to the power source in the base;

FIG. 18 is a side facing view of the nightlight show in FIG. 17;

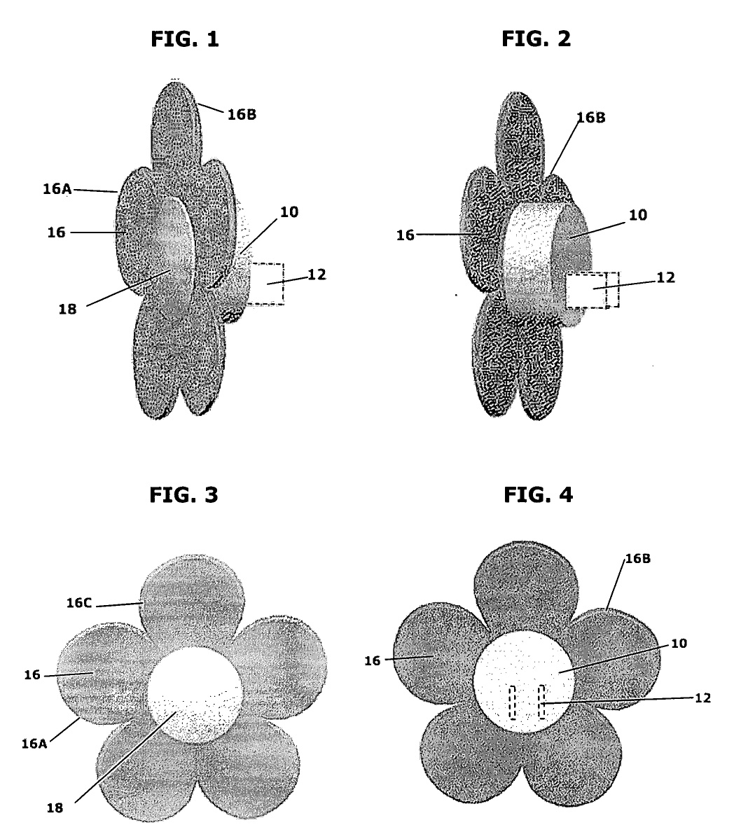

### DETAILED DESCRIPTION OF EXEMPLARY EMBODIMENT(S)

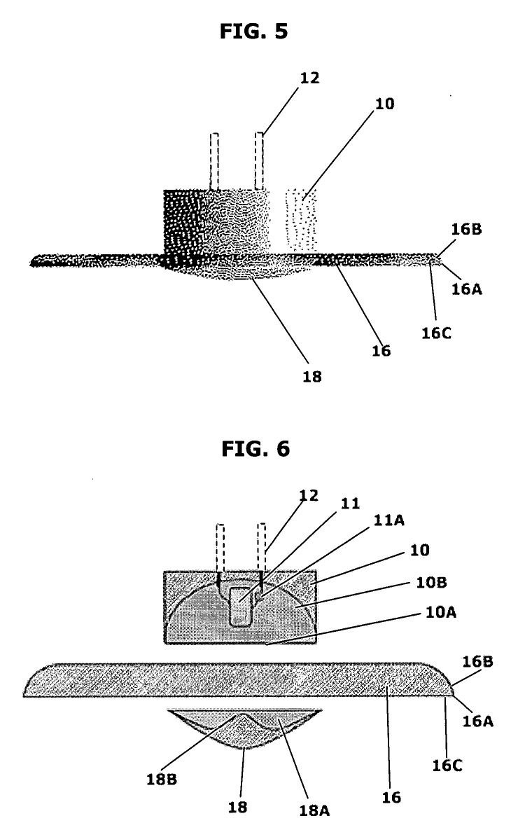

FIG. 6 shows a cut away view of the core components of one example of my invention, which are consistently labeled throughout all figures:

Base 10:
this is usually, though not necessarily, cylindrical in shape with one open side 10A. It may be comprised of opaque, translucent or transparent material. Inside this base is the light source 11 and electrical connector 12. The bottom interior 10B of the base 10 may be funnel-shaped or concave-shaped 10B, or of an alternately suited configuration to direct light back into the translucent or transparent core shape element 16. The bottom interior 10B of the base 10 may be comprised and/or treated with reflective material to direct light back into the core shape element 16.

Light Source 11:
this is comprised of a standard low-heat, low-power light source such as, but not limited to, one or more LED, OLED, NEON lights 11 wired with the appropriate resistors 11A and connections to the electrical connector 12.

Electrical Connector 12:
this delivers electrical power to the light source 11 from metal prongs 12 that extrude through the closed side of the base 10 and fit into a source of electricity such as an electrical wall socket. Alternate methods, such as but not limited to dry cell batteries, may be used to provide power to the light source 11. As such the metal prongs are shown in phantom lines.

Core Shaped Element 16:
this is the focal element illuminated by the light source 11, this extrudes beyond the diameter of the edge of the base 10. The core shaped element 16 is comprised of a rigid clear or colored translucent or transparent material such as, but not limited to, acrylic, resin or glass. Said core shaped element 16 may also be comprised of a flexible clear or colored translucent or transparent material such as, but not limited to, silicon. The edges 16A of the core shape element 16 are rough beveled 16B to greatly enhance the edge glow when looking at the core shape from virtually any angle, especially those closer to straight on, both when illuminated and in ambient light conditions. To further amplify the core shape element's 16 edge glow, it may be comprised of materials using new heat and light stable edge glow compounds.

Diffusing Cover Element 18:
this is usually, though not necessarily, disc-shaped and adhered to the core shape element 16 on the opposite side of the light source to reflect light back into the core shape element 16. It is usually comprised of an opaque or semi-translucent hard or soft material. The inner portion 18A of the diffusing cover element 18 may have a curved convex conical shape 18B or alternately suited configuration to direct light back into the translucent core shape element 16. The inner portion 18A of the diffusing cover element 18 may be comprised or treated with reflective material to direct light back into the core shape element 16.

The methods for creating the individual components, arrangement of wiring or connecting the light source 11 to the electrical connector 12 with the appropriate electrical components 11A and mounting them in the base 10 is well known by those with ordinary skill in the manufacturing, electronic, and mechanical arts, as is assembling and fusing all the components together to create the finished nightlight.

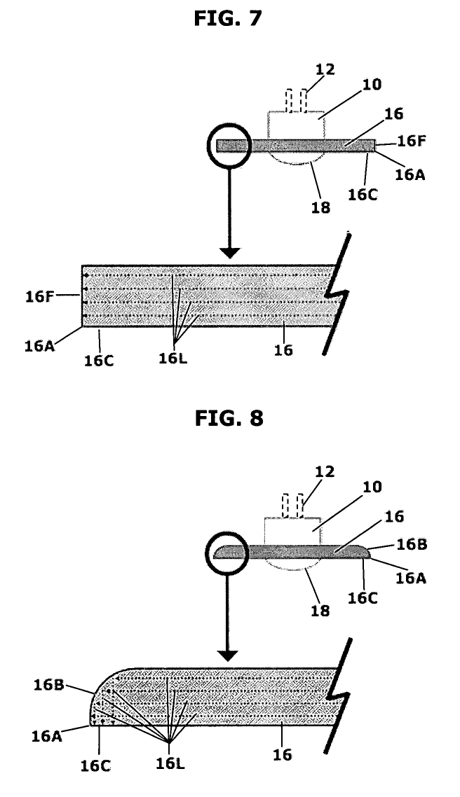

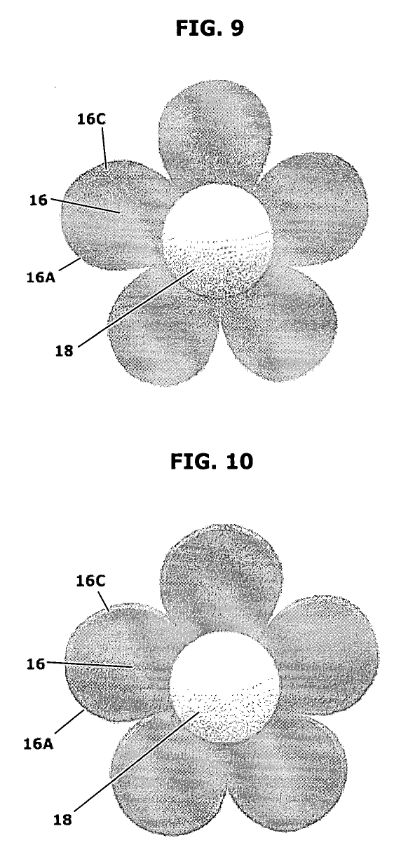

The key, non-obvious aspects to the invention are the materials in which the core shaped element 16 is comprised and the manner in which the outer edge 16A is shaped, treated and assembled. FIG. 7 illustrates that light waves 16L don't refract back to the facing edge 16C of a core shape element 16 with a standard flat edge 16F. The material comprising the core shape element 16 should be made with edge glow compounds that absorb UV light and re-admit that energy in longer wavelengths. Effectively this changes non-visible light to a visible wavelength and refocuses internal light reflection within the compound, emitting it more intensely along the edges 16A of a shape 16, thereby creating a glowing effect. As is detailed in FIG. 8, one side of the outer edge 16A of the core shaped element 16 should be one-quarter round rough beveled 16B. The rough beveled edge 16B of the decorative core shape element 16 refracts light waves 16L back to the facing edge 16C of said shape 16. As is illustrated in FIG. 10, the facing edge 16C of said core shape element 16 appears brighter than that of the center of the core shape element 16 or light source and is also visible when looking perpendicularly at the shape, not just from a side angle as with a standard flat edge 16F. This is true with core shape elements 16 comprised with our without edge glow compounds. As is show in FIG. 9, the facing edge 16C of said core shape element 16 doesn't appear brighter than that of the center of the core shape element 16 or light source and is not more visible when looking perpendicularly at the shape as it is from a side angle 16F.

As is outlined in FIG. 8 and FIG. 6, when the nightlight is assembled, the rough beveled edge 16B of the core shaped element 16 should be placed toward the base opening 10A so the edge 16B catches the most ambient and direct light and displays it to the facing edge of the shape 16C. For nightlights with enhanced durability, the core shaped element 16 should be made of a translucent or transparent flexible material such as silicon.

### ALTERNATE EMBODIMENTS

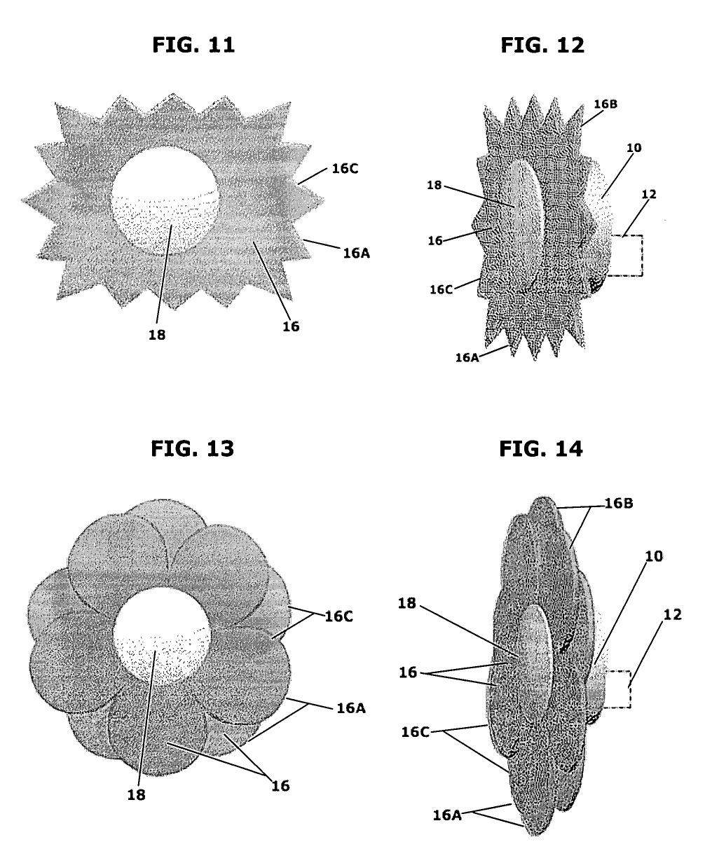

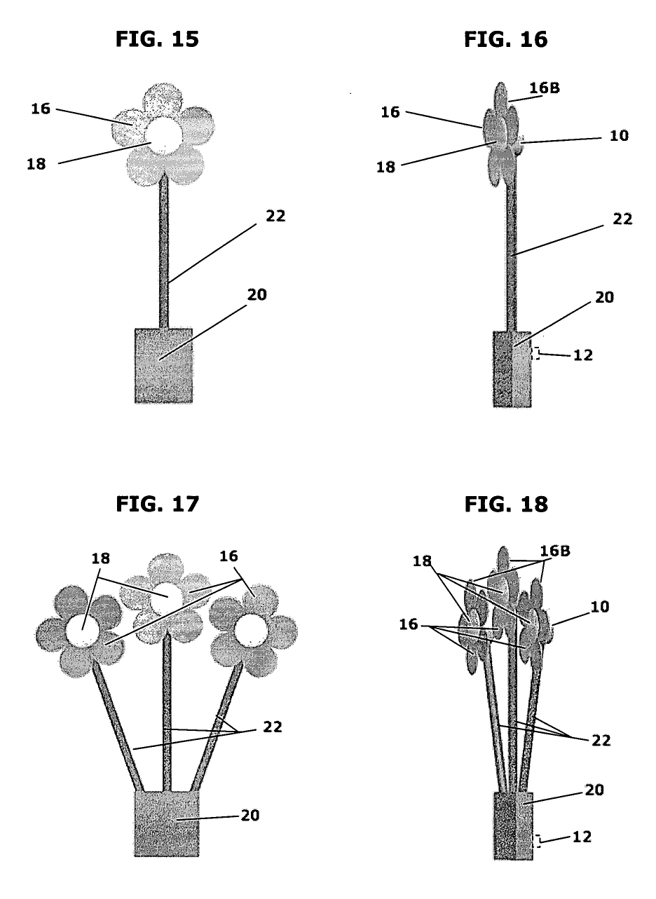

There are a number of alternate embodiments in which the edge glow of the core shaped element and/or the utility of the nightlights can be enhanced. Examples of these alternate embodiments are, but not limited to, the following:
As outlined in FIG. 11 and FIG. 12, the core shaped element 16 may take many unique forms such as, but not limited to, a flower, star, diamond, rectangle, butterfly or burst.
As is shown in FIG. 13 and FIG. 14, one or more core shaped elements 16 may be overset and overlaid, to create a more interesting design effect.
As is shown in FIG. 15, FIG. 16, FIG. 17, and FIG. 18, one or more nightlights built with any of the properties described herein may be assembled, with alternate base shapes 20 and/or flexible power extensions 22 to create a more interesting nightlight design or to provide greater light output than one similar sized nightlight.
The core shaped element may have a hole in the center to encase the light source to diffuse more light to its edges.
The core shaped element may extrude from one or more sides of such a base.
The core shaped element edge may be rough beveled after being smooth cast by being sanded, chemically etched, or altered in an alternate fashion.
The core shaped element edge may be rough beveled in a manner other than one-quarter round.
The back edge of the core shape element may be treated with another substance, such as light reflecting paint to further enhance the edge glow.
The core shaped element may be combined with and molded into the base shape with an open end so that the light source and connection to the power source may be later affixed or snapped into the open end.
A low-power, low-heat light source, like the low-profile flat light source in the GE Gelcore technology products could be utilized.
An alternate light source, such as, but not limited to, a black light, may be used in addition to alternate edge glow compounds that react correspondingly with the alternate light source.
Alternately to a diffusing cover element, a portion of the core shape element opposite the light source could be sanded, etched or painted with reflective materials to reflect light back into the translucent core shape element.
Designs or patterns may be etched on the surface of the core shape element, face diffusing element, or base.
The base may include a control like, but not limited to a switch, or a low-light sensor to manually or automatically disengage the power in daylight conditions.
The base may encompass a flexible prong protective sleeve or outlet retention screw to make the product more child-friendly.
The power source may be delivered through batteries and, in such an embodiment, the product would have space for the batteries in the base instead of electrical prongs, and a control like, but not limited to, a button, to turn the device on or off.
A mobile, battery powered nightlight may acquire alternate uses such as a bike light or personal safety light. As such it may have any number of alternate known configurations such, but not limited to, tension clips, loops or brackets for adhering to backpacks, belts, or bikes.
The power source may be delivered through an alternate source, such as through a USB or IEEE1394 connector or similar interface.
One or more white or colored lights may be used to provide different levels of illumination and/or match the color of the core shape. A control like, but not limited to, a button, may be used to switch between these levels or colors. A similar control may be used to cause the light to flash in one or more patterns.
The methods and principles detailed herein may be applied to touch lamps, pendant lamps, desk lamps, light strings and other lighting embodiments. Extruded electrical receptacles and plugs, such as, but not limited to, those in power cords, power outlets, and power strips may also be created.
Other non-obvious extruded glowing objects include, but are not limited to: drawer handles, magnets, wall or fridge hooks, napkin rings, bottle tops, vases, timers, clocks, pot tops, blender tops, pot handles, smoke detectors, headlamps, earrings, rings, and hair clips.

### SUMMARY, RAMIFICATIONS AND SCOPE

My method of enhancing nightlight edge illumination is preferable over previous methods because it makes visible the illuminated edges when the shape is viewed perpendicularly or face on whether illuminated or not—key for manufacturers in packaging and for consumers enjoying the nightlight in the daytime. This inexpensive process enhances the decorative aspect of nightlights by creating a unique new look for extruded nightlights more evenly distributes light to the edge of the core shape element and illuminates the edge without a light source behind it. The materials described herein also create a safer more durable nightlight that is more resistant to breakage, particularly for those with intricately shaped designs.

The exemplary and alternate embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

I claim:

1. A decorative light comprising;
A light emitting element within a base, a power source connected to said light emitting element, a translucent or transparent core shaped element which partly or fully covers or surrounds said light emitting element, said core shaped element partly or fully covering one or more sides of said base, where said core shaped element further comprises an enhanced edge illumination property.

2. A light as in claim 1 where a diffusing cover element partly obscures one or more sides of said core shaped element opposite the lighting element to redirect light back into said core shaped element to further enhance the edge illumination property.

3. A light as in claim 1 where said core shape element is comprised of a rigid translucent or transparent material such as acrylic, glass or a derivative or substitute thereof.

4. A light as in claim 1 where said core shape element is comprised of a flexible translucent or transparent material such as silicon or a derivative or substitute thereof.

5. A light as in claim 1 where said core shape element is relatively planar.

6. A light as in claim 1 where said core shape element is shaped to resemble a flower with rounded petals.

7. A light as in claim 1 where the edge glow property is produced with edge glow type plastic doping.

8. A light as in claim 1 where the edge glow property is produced with a rough beveled edge.

9. A light as in claim 1 where the edge glow property is produced with edge glow plastic doping and also comprises a rough beveled edge.

10. A light as in claim 1 where the edge glow property is produced with a rough beveled edge and an etched edge.

11. A light as in claim 1 where the edge glow property is produced with edge glow plastic doping and an etched edge.

12. A light as in claim 1 where the edge glow property is produced with edge glow plastic doping, a rough beveled and etched edge.

13. A light as in claim 1 where the light emitting element is powered by AC or DC current.

14. A light as in claim 1 where the light emitting element is powered by one or more low voltage dry cell batteries.

15. A low level lighting article, said article comprising of, a low-heat light source from one or more LED, OLED or NEON bulbs or alternative thereof, a means for powering said light source, such as prongs for an electrical outlet or batteries, a translucent or transparent core shape element extruding beyond the center of the source of illumination.

16. A low level lighting article as in claim 15, where said core shape element is extruded beyond the center of the power source, said element being made of a rigid or flexible material with an existing or enhanced edge glow compound.

17. A low level lighting article as in claim 15, where said core shape element is extruded beyond the center of the power source, said element being made of a rigid or flexible material with an existing or enhanced edge glow compound, with a ¼ round rough beveled edge.

18. A low level lighting article as in claim 15, where said core shape element is extruded beyond the center of the power source, said element being made of a rigid or flexible material without an existing or enhanced edge glow compound, with a ¼ round rough beveled edge.

19. A low level lighting article as in claim 15, where said core shape element is extruded beyond the center of the power source, said element being made of a rigid or flexible material with an existing or enhanced edge glow compound, with a ¼ round rough beveled edge, and an etched edge.

20. A low level lighting article as in claim 15, where said core shape element is extruded beyond the center of the power source, said element being made of a rigid or flexible material without an existing or enhanced edge glow compound, with a ¼ round rough beveled edge, and an etched edge.
